(19) United States
(12) Patent Application Publication
(10) Pub. No.: US 2002/0074764 A1
(43) Pub. Date: Jun. 20, 2002

(54) Bicycle child carrier trailer

(76) Inventors: Scott R. Allen, Fieldbrook, CA (US); Joseph J. Settelmayer, Fieldbrook, CA (US); James R. Penny, Arcata, CA (US); Duncan G. Robins, McKinleyville, CA (US); Steven J. Cole, Arcata, CA (US)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 09/861,019

(22) Filed: May 18, 2001

Related U.S. Application Data
(60) Provisional application No. 60/205,506, filed on May 19, 2000.
(60) Provisional application No. 60/262,174, filed on Jan. 16, 2001.

(51) Int. Cl. B62K 27/00

(52) U.S. Cl. 280/204

(57) ABSTRACT

A bicycle trailer has a bed portion supported by a frame assembly and a pair of wheels for transporting the bed portion over ground. The tongue member extends forward from the frame assembly. A hitch assembly is located on a distal end of the tongue member for coupling the trailer to a bike. The hitch assembly may include a ratchet device that permits tightening of a clamp to the bike preventing untightening of the clamp. Front and back hub members allow the trailer to be vertically collapsed to substantially reduce the side-to-side dimension of the trailer for storage or transport.

### CROSS REFERENCE TO RELATED APPLICATION(S)

This application claims priority to Provisional Applications Ser. No. 60/205,506 filed May 19, 2000 entitled “Bicycle Child Carrier Trailer” and Ser. No. 60/262,174 filed Jan. 16, 2001 titled “Quick-Release Locking Frame Hub”, both of which are hereby incorporated by reference.

### FIELD OF THE INVENTION

The present invention relates to trailers for bicycles and more particularly to a bicycle trailer adapted to carry children or other cargo.

### BACKGROUND OF THE INVENTION

Bicycle riding is a popular recreational activity for families. However, bicycle riding requires a certain amount of coordination, which children do not develop until they are approximately 4-7 years old. Even in the cases where small children are capable of riding a bicycle, they often do not have the strength and stamina to keep up with adults on long rides. Also, young riders do not have the judgment necessary to avoid dangerous traffic situations when riding on roads. Therefore, some type of accommodation must be made for small children to allow the family to ride together.

One way to transport small children on bicycle rides is to provide an auxiliary seat mounted to the adult's bicycle. This is generally acceptable for one child, but not practical for two children or for larger children. Child seats on bicycles often require semi-permanent installation of hardware to secure the seat to the bicycle, and may make a bicycle difficult for some people to balance.

Another way to transport small children is to utilize a trailer attached to the bicycle. One advantage of a trailer is that it can be sized to accommodate more than one child. Unfortunately, child carrier trailers are rather bulky and difficult to transport to the site where the ride it to take place. For instance, many bicycle trailers are formed from a large plastic shell that cannot be folded for storage or transport. Although some trailers can be folded, existing designs suffer a number of disadvantages. For instance, some trailers do not fold small enough to be easily loaded in most cars. Other trailers are relatively difficult to fold and unfold. In some cases the seats must be removed and in other cases the tires must be taken off. As a result, these carriers are inconvenient to transport.

Another limitation of bicycle trailers is that the mechanisms for attaching the trailer to the bicycle suffer from a number of drawbacks. In particular, some coupling mechanisms are unnecessarily complex. Other mechanisms are too difficult to attach and remove from the bicycle and/or don't provide reliable securement of the trailer to the bicycle.

### BRIEF DESCRIPTION OF THE FIGURES

FIG. 1 is an isometric view of a bicycle trailer constructed according to the present invention.

FIG. 2 is a front elevation view of a bracket forming part of the trailer of FIG. 1.

FIG. 3 is a side elevation view of the bracket of FIG. 2.

FIG. 4 is an isometric view of the bicycle trailer of FIG. 1 in a folded configuration.

FIG. 5 is a front elevation view of a portion of a frame assembly adjacent the bracket of FIGS. 2 and 3.

FIG. 6 is a front elevation illustrating folding of the portion of the frame assembly of FIG. 5.

FIG. 7 shows the inner surface of lock out members shown in FIG. 5 and 6.

FIG. 8 is a top elevation view of a connector of the frame assembly.

FIG. 9 is a side elevation view of the connector of FIG. 8.

FIG. 10 is a front elevation view of the connector of FIG. 8.

FIG. 11 is a front elevation view showing folding of a cross bar of the frame assembly.

FIG. 12 is a side elevation view of a wheel bracket.

FIG. 13 is a front elevation view of the wheel bracket of FIG. 12.

FIG. 14 is a side elevation view of the wheel bracket of FIG. 12 showing passage around an arcuate section of an elongate member.

FIG. 15 is a rear elevation view of a fender.

FIG. 16 is a top elevation view of the fender of FIG. 15.

FIG. 17 is an exploded view of a hitch assembly.

FIG. 18 is a cross-sectional view through the hitch assembly of FIG. 17.

FIG. 19 is an isometric view of a seat mounted in the frame assembly.

FIG. 20 is an isometric view of the a cover for the trailer of FIG. 1.

FIG. 21 is a section view through the covered trailer.

FIG. 22 is a partial front view of a bracket assembly, according to an alternate embodiment invention.

FIG. 23 is a front cut away view of the bracket assembly shown in FIG. 22.

FIG. 24 is a front view of the bracket shown in FIG. 23, in a collapsed position.

FIGS. 25 and 26 show cross-sectional views through the bracket assembly of FIG. 24, in locked and unlocked positions, respectively.

FIG. 27 is an exploded view of the bracket assembly shown in FIGS. 22-26.

FIG. 28 is a front cut away view of a bracket assembly for another embodiment of the invention.

### DETAILED DESCRIPTION

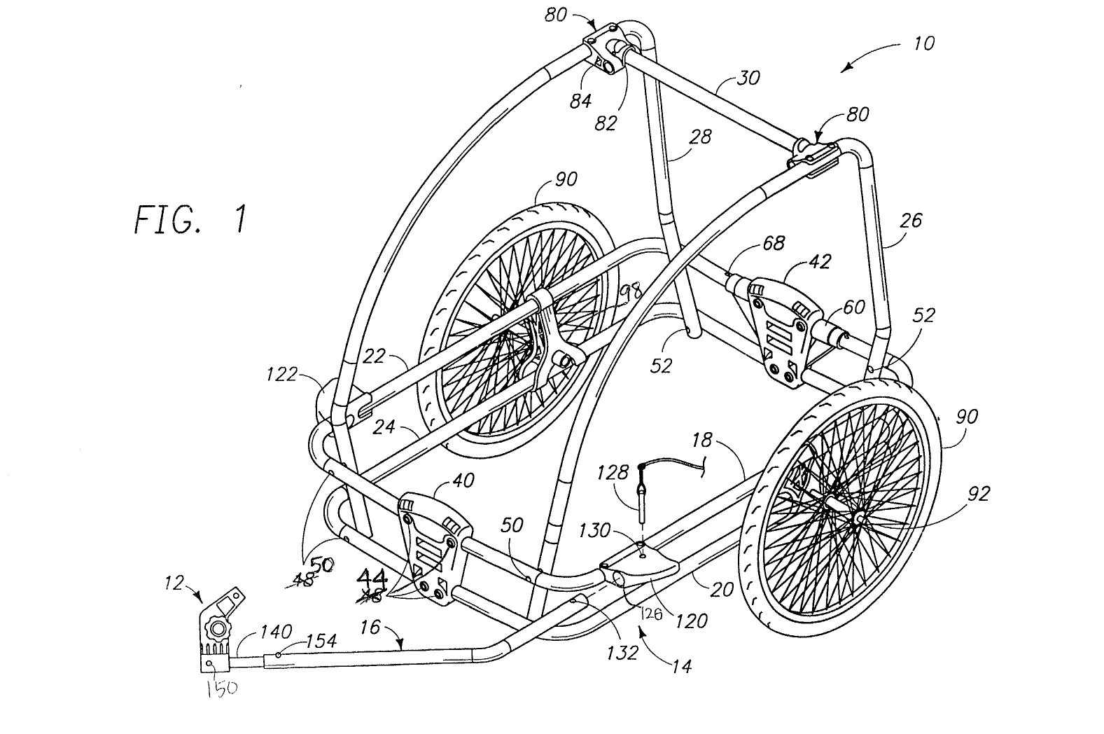

A bicycle trailer constructed according to the present invention is shown generally at 10 in FIG. 1. Although the trailer would normally incorporate a cover and seat, these elements are omitted in FIG. 1 to more clearly illustrate the basic framework of the trailer. The cover and seat are depicted in subsequent figures and described below.

Trailer 10 includes a hitch assembly 12 adapted to secure the trailer to a bicycle. The hitch assembly is connected to a frame assembly 14 forming the body portion of the trailer by a tongue 16. Frame assembly 14 includes left upper and lower U-tubes 18, 20 and right upper and lower U-tubes 22, 24. Frame assembly 14 also includes left and right vertical U-tubes 26, 28. Vertical U-tubes 26, 28 are connected at the top by a crossbar 30. Tubes are preferably formed of 0.065-inch thick one-inch diameter aluminum tubing and bent to shape from single pieces, although multiple pieces could also be joined to form the various shapes.

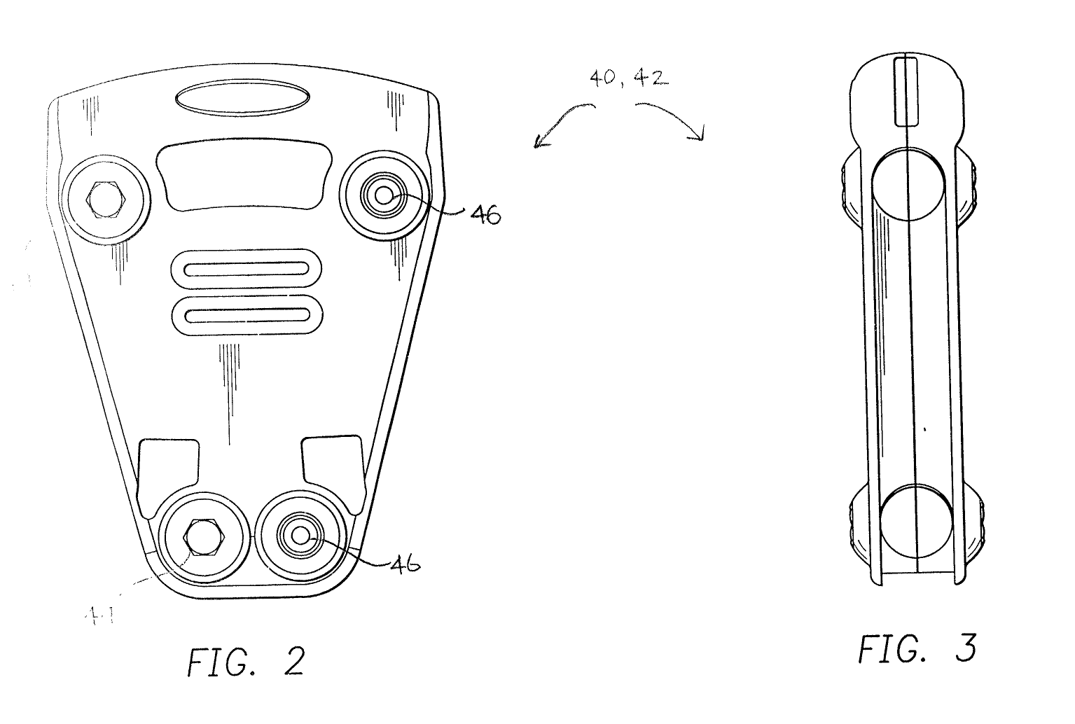

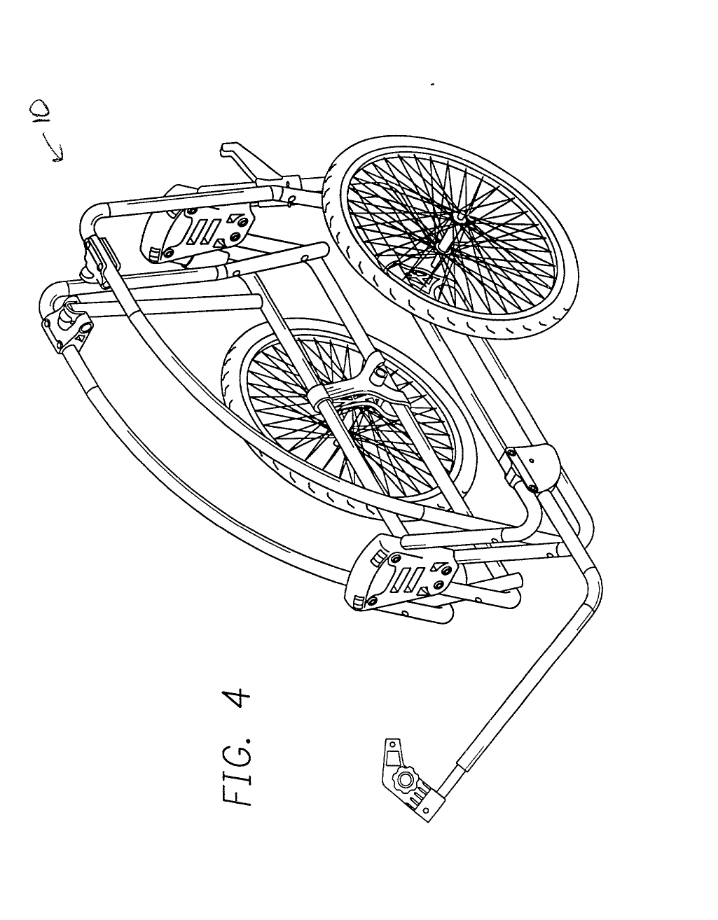

The left and right upper and lower U-tubes are connected at their ends by brackets 40, 42. See FIGS. 2-3. The brackets are substantially identical and each is preferably molded of 14% glass-filled nylon in two symmetric halves, as shown in FIG. 3. It should be noted that where specific materials are mentioned herein, they are simply indications of suitable materials, and other materials having similar structural characteristics could be readily substituted. The bracket halves are held together by four bolts 44, which also pass through holes 46 (not shown) formed in the end of the tubes to provide a pivotal connection between the tubes and brackets. The upper and lower tubes are also connected to the vertical tubes by bolts that pass through holes 50, 52 in the upper/lower and vertical tubes, respectively. This arrangement of pivot joints forms a parallelogram that allows the trailer to be folded by raising the brackets upwardly. See FIG. 4. The portions of the frame on each side of the brackets can be viewed as left and right frame portions. Each frame portion collapses essentially as a unit toward the center.

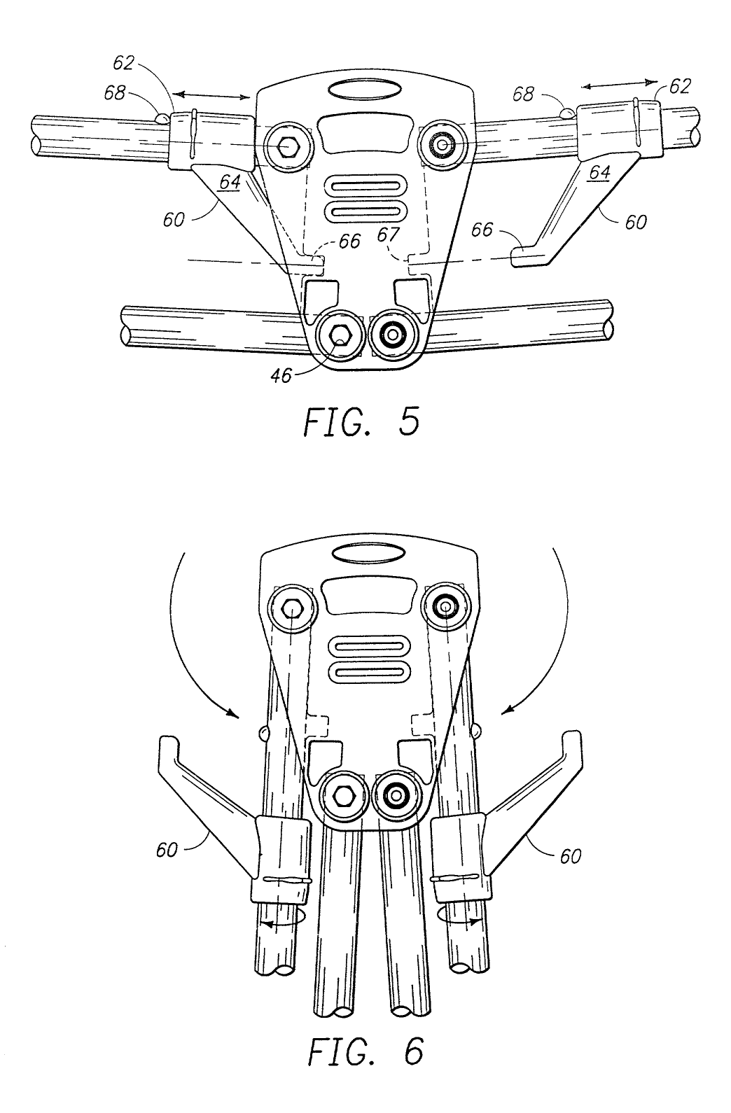

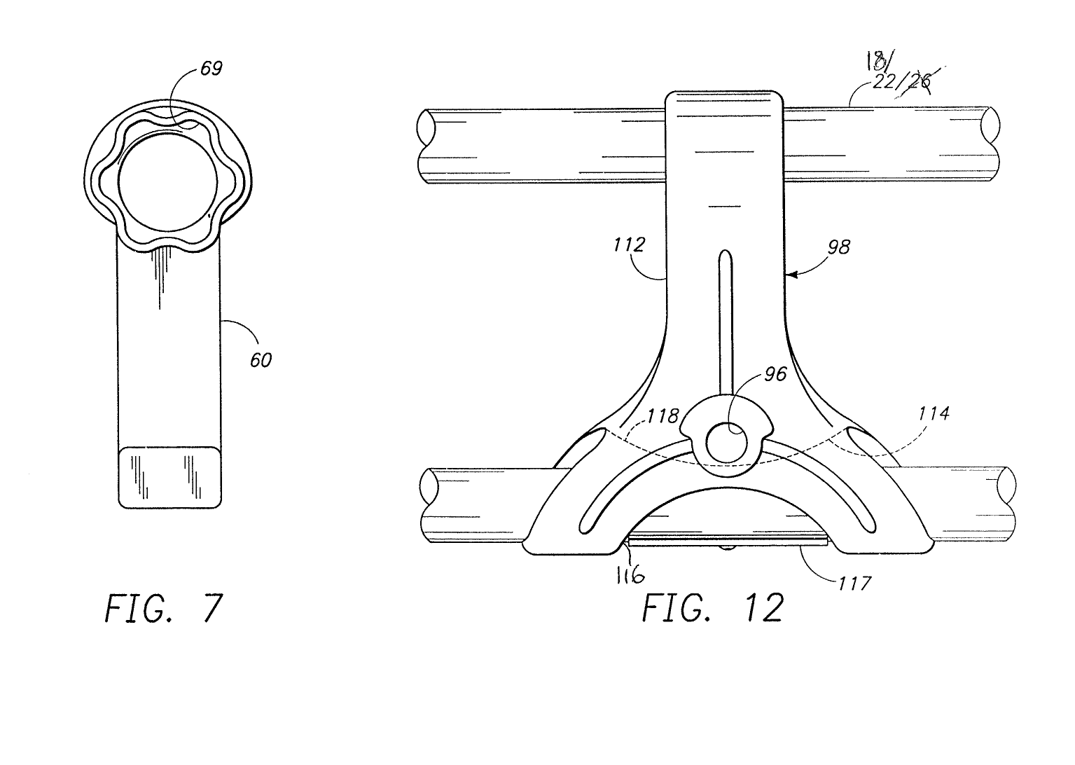

As illustrated in FIGS. 5 and 6, a pair of lock out members 60 are operable, when engaged, to prevent the trailer from folding. Lock out members 60 each include a band 62 slideably engaged over the corresponding upper tube. An arm 64 extends down from the band and toward the adjacent bracket, terminating in a finger 66. Finger 66 fits into a corresponding pocket 67 formed in the brackets to prevent the U-tube from pivoting downwardly. An outwardly biased spring button 68 mounted in each upper U-tubes prevents the lock out members from unintentionally disengaging from the brackets. The frictional contact between the button and the contoured inner surface 69 of the band also tends to hold the lock out members in a stable position when disengaged from the bracket. The contoured inner surface 69 of lock out members 60 is shown in FIG. 7.

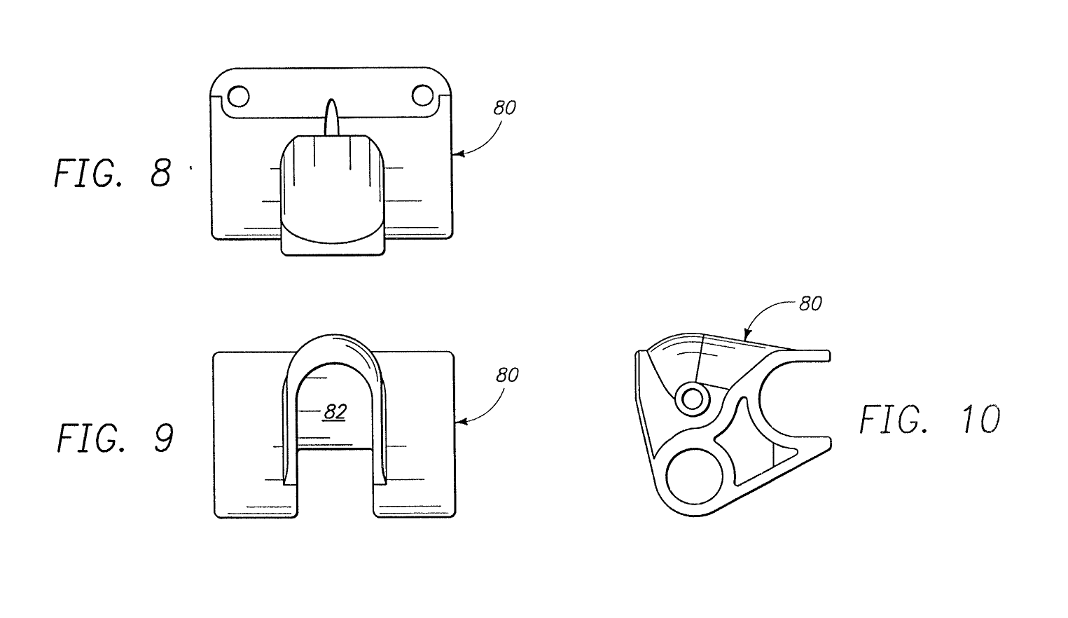

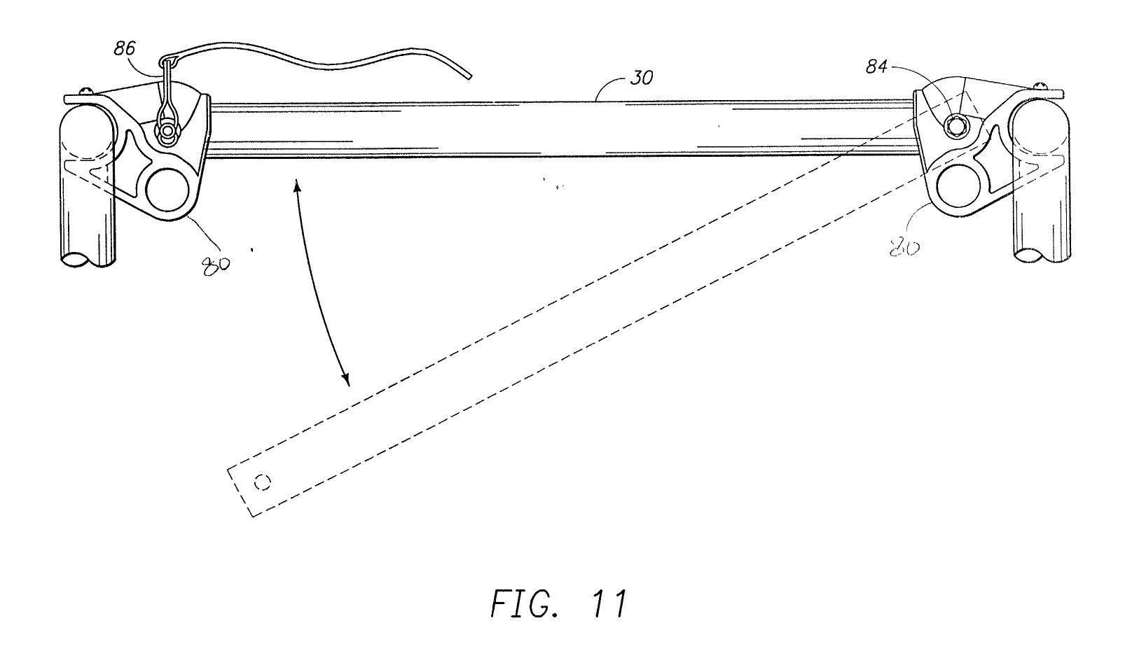

Crossbar 30 is coupled to the vertical tubes by connectors 80 located at each end of the crossbar. See FIGS. 8-10. The connectors are preferably formed of 14% glass-filled nylon and are bolted to the vertical tubes and include a recess 82 adapted to receive an end of the crossbar. One end of the crossbar is pivotally connected to the associated connector vertical tube by a bolt 84, while the other end is selectively connected to the associated connector by a safety pin 86. To fold the trailer, the safety pin is removed, allowing the crossbar to swing down and out of the way, as shown in FIG. 4 and 11. Crossbar 30 is preferably formed as a unitary member, i.e. without foldable joints, to provide maximum strength and stability when connected between the vertical tubes.

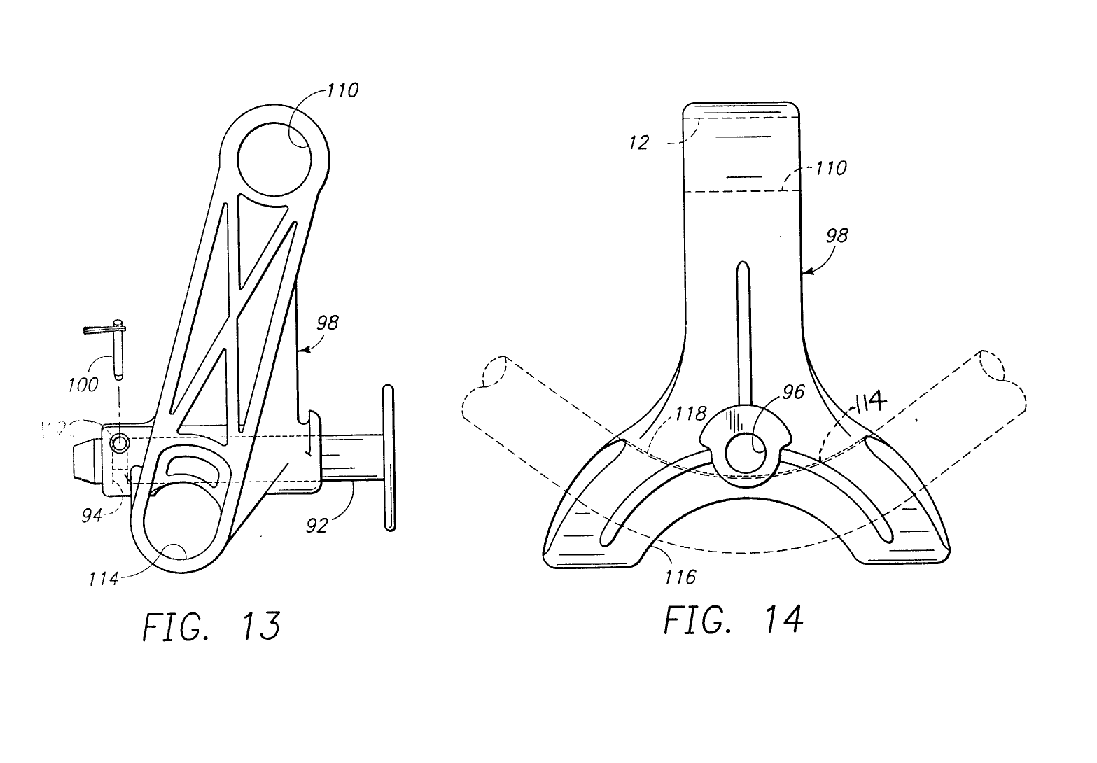

As shown in FIGS. 13 and 14, frame assembly 14 is supported by two wheels 90. Each wheel includes an axle 92 with a groove 94 formed at the end. The axle fits through a hole 96 formed in a wheel carrying structure or wheel bracket 98. The wheel bracket is preferably molded from 33% glass-filled nylon and is illustrated in additional detail in FIGS. 12-14. A wheel pin 100 fits through a locking hole 102 that partially intersects the axle hole 96 and engages groove 94. This arrangement allows the wheels to be quickly and easily removed when necessary, but otherwise retains them securely mounted to the bracket.

Bracket 98 includes an upper aperture 110 adapted to receive upper tube 18 or 22. A neck region 112 connects the upper aperture to a lower aperture 114 that is adapted to receive lower tube 20 or 24. Lower aperture 114 includes a lateral opening 116 that allows the bracket to be installed over a previously bent tube. The opening allows the radius of the bend to project out of the generally cylindrical internal shape of the lower aperture. The upper edges of the lower aperture are also slightly curved in at 118 to further facilitate sliding the bracket around the arcuate portion of the tube. Similarly, the upper aperture has an internal surface 121 that may be deformed from cylindrical sufficiently to allow the bracket to slide around the bend in upper tube 18 or 22, if necessary. Because the upper aperture is significantly shorter, the deformation from cylindrical is substantially less than is required on the lower aperture. Once the bracket is installed on the tubes, it is held in place by a stopper plate 117 that is riveted to the lower tube inside of opening 116. It should be noted that the bracket is free to rotate around the tubes to a limited extent to permit folding.

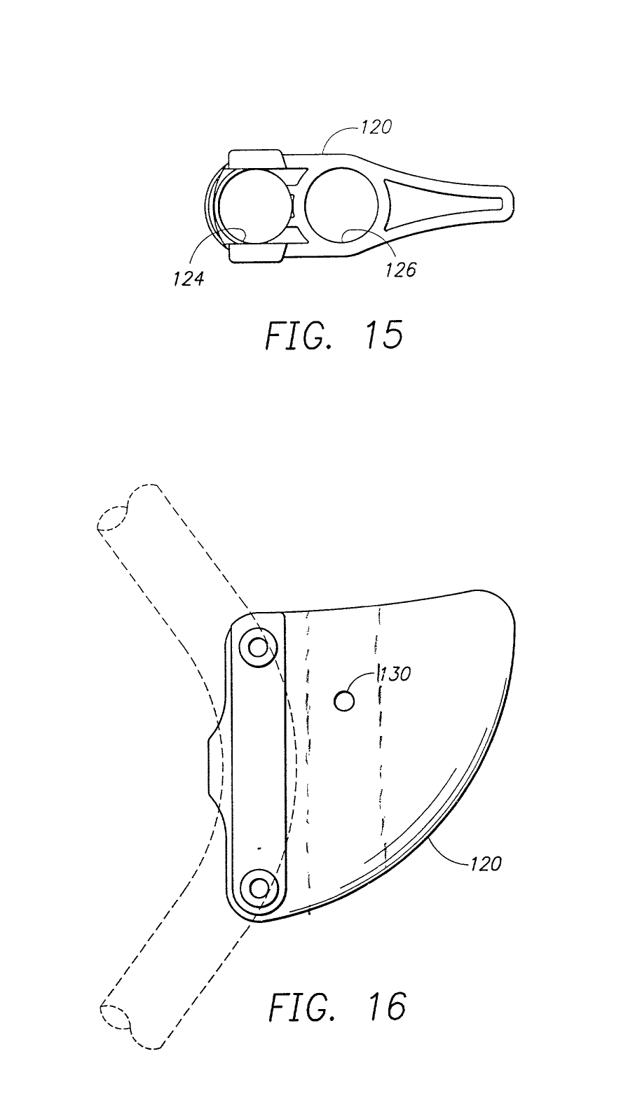

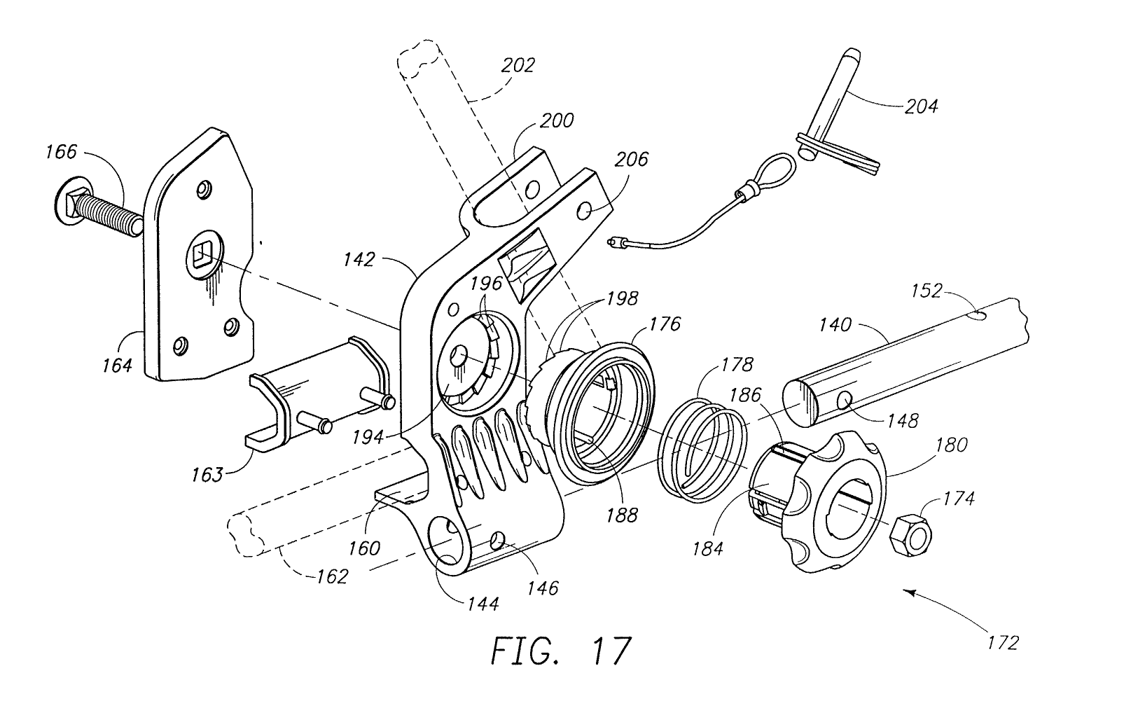

Frame assembly 14 includes a pair of fin-like fenders 120, 122 mounted to upper tubes 18 and 22, respectively. See FIGS. 15 and 16. Each fender is preferably molded from 14% glass-filled nylon and includes a passage 124 that fits over the corresponding tube. As with the wheel brackets, the passage is shaped to permit passage around the corner of the bent tube. In particular, each end of the passage is open on one side to provide the needed clearance. The fenders act to deflect the trailer away from posts or other vertical obstacles that might otherwise catch between the wheels and the frame. However, because the fenders do not wrap around the wheels, they do not interfere with the lateral removal of the wheels.

Fender 120 also serves as a mounting point for tongue 16. In particular, fender 120 includes bore 126 sized to receive the end of the tongue. A locking pin 128 passes through a transverse locking bore 130 in the fender and a corresponding bore 132 in the end of the tongue to secure the tongue in place. When the trailer is to be transported, the locking pin can be removed to allow the tongue to be detached.

Hitch assembly 12 is coupled to the free end of the tongue by a flexible member 140. See FIG. 17. The flexible member essentially acts as a universal joint to allow the trailer to roll, pitch and yaw relative to the bicycle during use. Any suitable flexible material may be used for the flexible member, and a preferred material is urethane. Of to course mechanical U-joints could also be used. The hitch assembly includes a hitch body 142 with a receptacle 144 adapted to receive the flexible member. The hitch body is preferably molded from 14% glass-filled nylon. A pair of transverse holes 146, 148 in the hitch body and flexible member, respectively, receive a bolt 150 to secure the two pieces together. A similar pair of transverse holes 152, 154 in the flexible member and leading end of the tongue also receive a bolt to couple these pieces together.

An elongate groove 160 formed along the lower edge of the hitch body fits over chainstay 162 on the bicycle. An elastomeric pad 163 protects the chainstay. A clamp plate 164 fits over the groove to securely capture the chainstay in the groove. The clamp plate is biased against the chainstay by a bolt 166 that extends through the plate and through the hitch body. The bolt is tightened by a knob assembly 172.

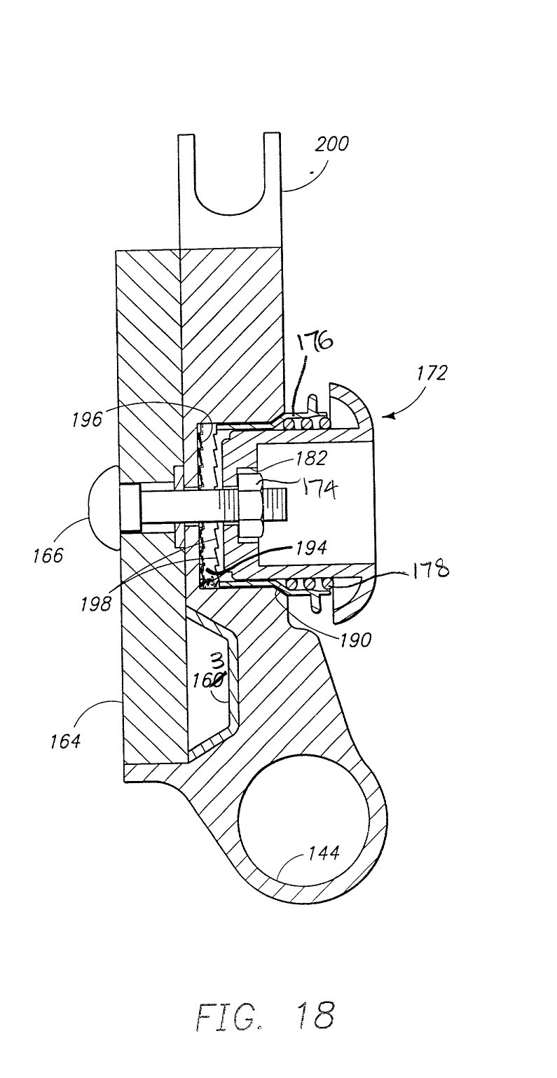

As shown in FIGS. 17 and 18, knob assembly 172 includes a nut 174, a nut ratchet 176, a spring 178 and a knob or tightening member 180. The nut fits into a hexagonally shaped recess 182 in a shaft portion 184 of knob 180. The outer surface of the shaft portion includes ribs 186. Nut ratchet 176 fits telescopically over shaft portion 184 and includes tracks 188 shaped to receive ribs 186 forming a securement mechanism to prevent the knob from rotating relative to the ratchet. The spring fits over the shaft portion and presses against the top of the knob and against a shelf 190 formed in the nut ratchet. See FIG. 18. This arrangement rotationally connects the knob and ratchet so that they must turn together, but allows the ratchet to telescope along the knob.

The knob assembly threads on over bolt 166 and is received in a ratchet socket 194. The ratchet socket includes a ring of serrations 196. The serrations interact with corresponding serrations 198 formed on the end of nut ratchet 176 to prevent counterclockwise rotation which would tend to loosen the nut and therefore unhitch the hitch assembly. The slope of the serrations allows the knob assembly to be tightened without any special consideration other than rotating the knob. However, to loosen the knob assembly, the nut ratchet must be grasped and drawn back toward the top of the knob, to thereby disengage the serrations and permit counter-clockwise rotation. This mechanism can be described as a locking or a ratchet closure, anti-backspin mechanism or safety closure adapted to prevent accidental loosening. The knob and nut ratchet are preferably molded from 14% glass-filled nylon.

The hitch body also includes an upper fork 200 adapted to fit around the seatstay 202. A safety pin 204 passes through a pair of openings 206 in the end of the fork to prevent the fork from inadvertently coming off of the seatstay during use. This connection provides an added margin of safety in the event the chainstay gripping mechanism should loosen or fail in some way.

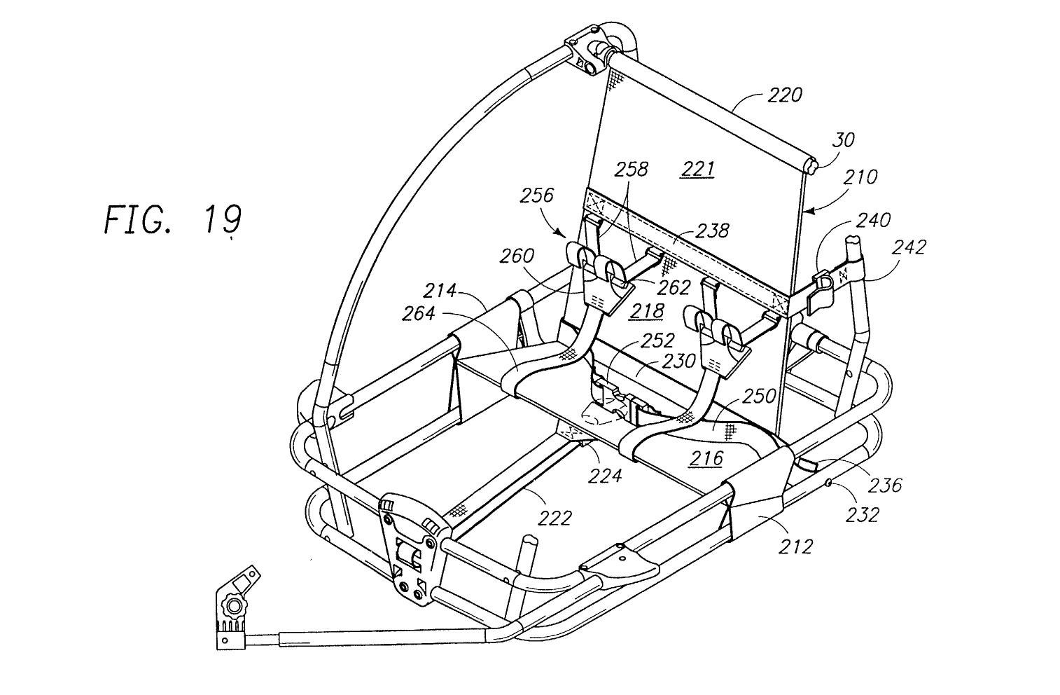

A fabric seat 210 is mounted to frame assembly 14 to support children riding in the trailer. See FIG. 19. Seat 210 includes left and right lateral support bands 212, 214 that fit over the left and right lower and upper tubes. The bands support and position a bench portion 216 that extends between the bands. A backrest portion 218 extends up from the back of the bench to a top sleeve 220 that fits over crossbar 30. An upper portion 221 of the backrest is formed of a stretchy or elastic material, such as LYCRA. This is to more comfortably accommodate the helmets of passengers in the trailer. Thus, the material should be sufficiently stretchy to accommodate a passengers helmet without pushing forward uncomfortably on the passengers head. The lower portion of the backrest is preferably made of a relatively inelastic material such as nylon fabric so that it can be sufficiently tensioned to provide adequate support.

A system of straps serves to tension and secure the seat. In particular, a forward strap 222 extends from the front center of the seat to the forward bracket 40 and back. The strap includes a buckle 224 to allow the tension to be adjusted and a pouch 226 (not shown) to hold the free end of the strap after adjustment. The pouch includes a small patch of hook and loop-type fastener allowing it to be secured in place against the bottom of the bench. A bottom strap 230 extends between bolts 232 on the lower tubes along the intersection between the bench and backrest. Each end of the bottom strap includes a buckle 236 to allow the tension to be adjusted to center the seat. A shoulder strap 238 extends across the backrest about midway to the top sleeve. Each end of the shoulder strap is connected to a corresponding vertical tube through a buckle 240 to allow the centering and tension to be adjusted. The ends of the shoulder strap include hoops 242 that fit around the vertical tubes and are free to move therealong.

A safety belt system includes a lap belt 250 with a quick disconnect buckle 252 that allows the sections to be separated and rejoined easily. Buckle 252 also allows adjustment of the length of the lap belt to achieve proper restraint. The ends of the lap belt are secured to the frame assembly by bolts 232 together with the bottom strap. A shoulder harness 256 is provided for each child and includes two upper straps 258 that join at a chest pad 260. A quick disconnect buckle 262 is provided at the connection to the chest pad to allow the harness to be opened when seating the child. Buckle 262 also allows the length of the upper straps to be adjusted for proper fit. The chest pad is connected by a lower strap 264 to the front of the bench portion.

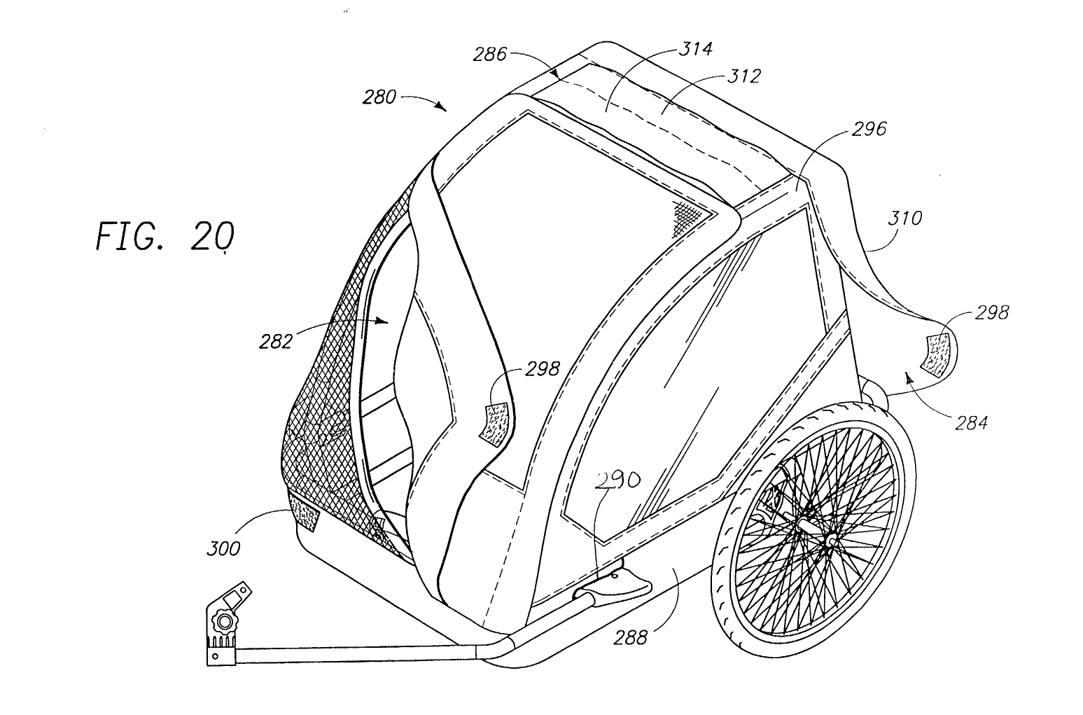

Frame assembly 14 is enveloped in a fabric cover 280. See FIG. 20. The cover is somewhat tube-shaped with front and rear openings 282, 284 and a continuous central band 286, and is preferably formed of nylon fabric. A bottom section 288 fits around and forms a bottom to the perimeter formed by the left and right lower tubes. The sides of the cover at the forward upper portion are preferably formed of a mesh fabric to provide a window-like area. The section adjacent the front opening folds partially over the vertical tubes to secure the cover in place on the frame assembly as the frame is unfolded. The folded-over portion creates the tension necessary to support the floor of the trailer formed by the bottom section. The cover includes lateral openings 290 adapted to pass the fenders. The presence of the fender in the openings helps to further secure the cover in a fixed position on the frame assembly.

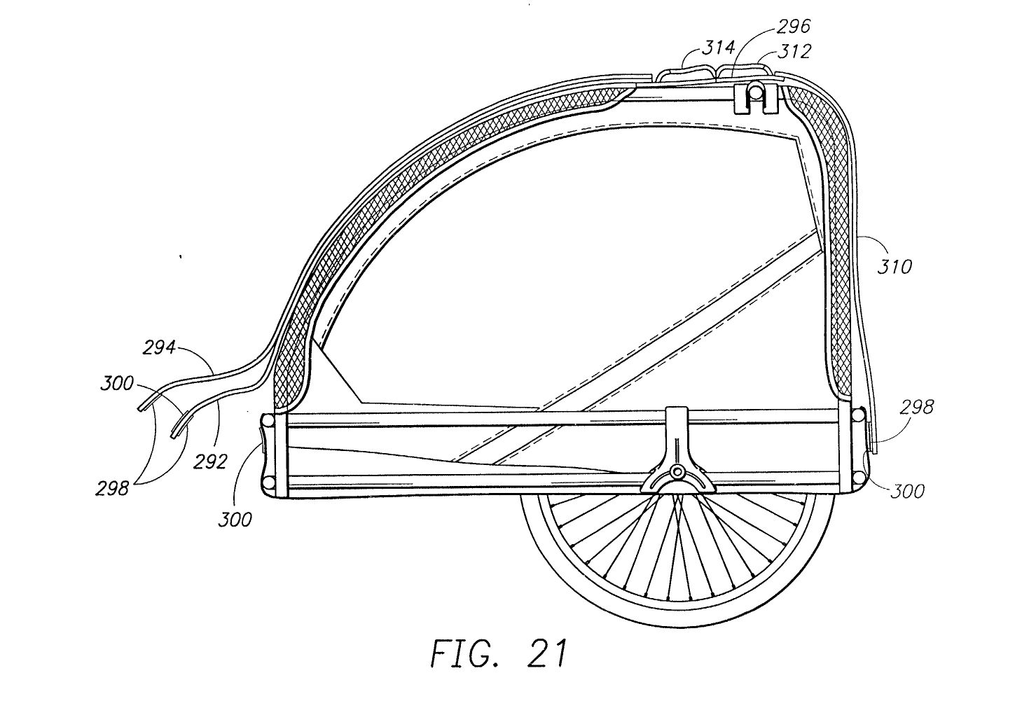

Cover 280 includes a front debris screen 292 and a front windscreen 294. See FIG. 21. The hatches or screens are attached to the cover adjacent a band 296 of material forming the top of the cover between the vertical tubes. The debris screen is preferably formed of a mesh-like material to allow riders to see out but be protected from rocks or other objects kicked up by the towing bicycle. The windscreen is preferably formed of a clear flexible sheet such as vinyl to block wind or rain as necessary. Each of the screens includes a hook and loop-type band 298 at the free end that can be selectively secured to a corresponding band of material 300 formed on the cover and on the outer surface of the covers.

A rear screen or hatch 310 is provided to selectively seal the rear opening. The rear hatch is preferably formed of a fabric material similar to the remainder of the cover and is attached adjacent band 296. The free end of the rear hatch is secured to the cover by a band of hook-and-loop type material similar to that used on the front screens. A pair of pockets 312, 314 are formed in the band of material to receive the screens and rear hatch when they are folded up. This provides a clean appearance and secure storage. Alternatively, strips of hook and loop material can be used to secure the screens and hatch in a rolled up configuration.

To fold trailer 10, the user simply retracts lock out members 60 and safety pin 86 in the crossbar and lifts the brackets to draw the sides of the trailer together. It is not necessary to remove the seat or disconnect any of the various straps and gravity essentially folds the trailer when the bracket is lifted. If necessary the tongue can be removed to further reduce the size of the folded trailer. Similarly, the wheels can be removed to minimize the folded dimensions, however, the folded trailer will fit in most vehicles with the wheels still attached.

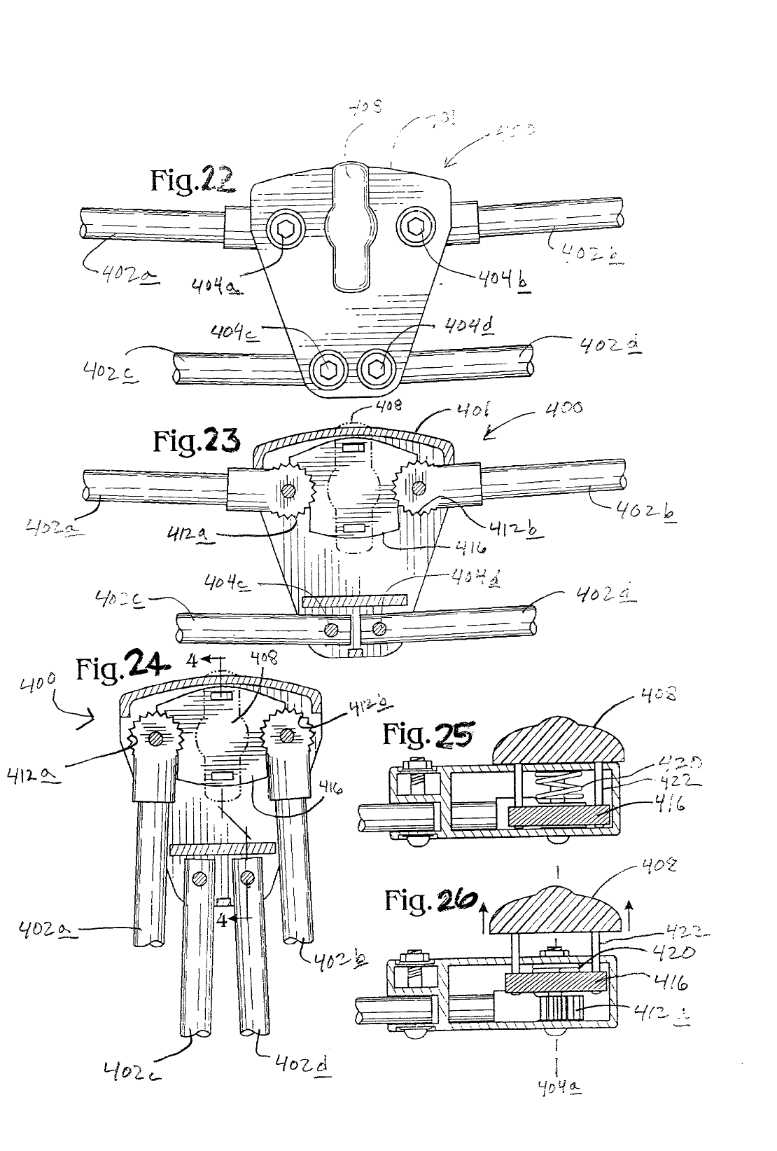

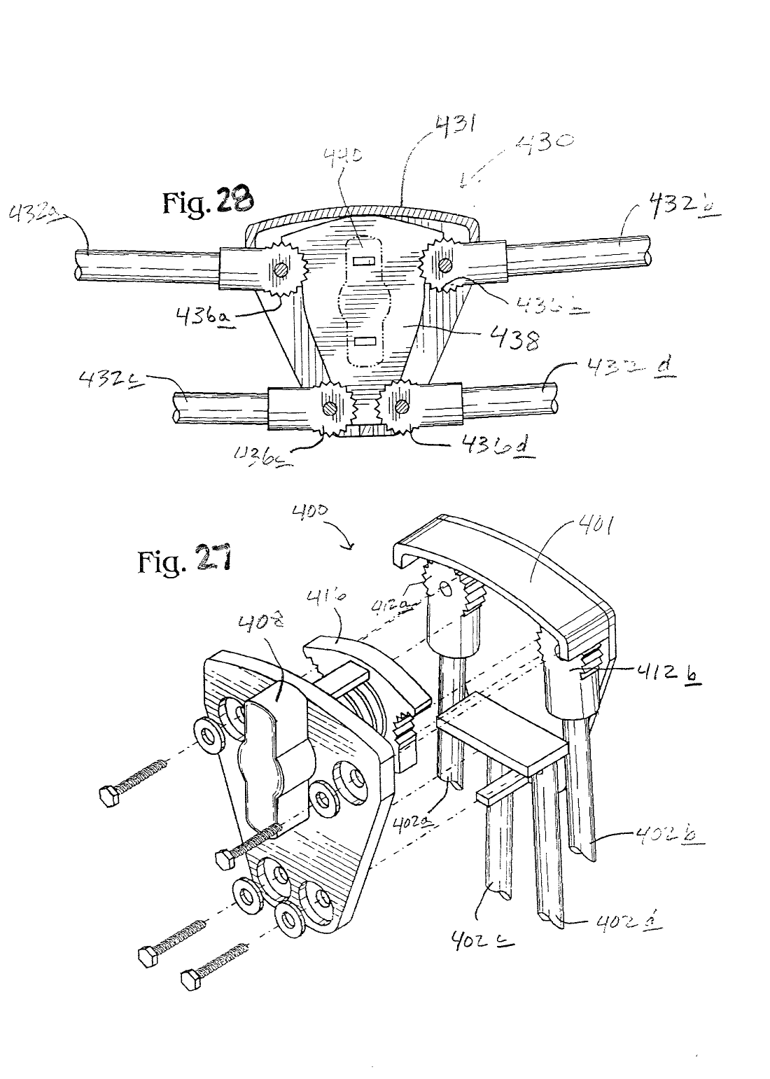

FIG. 22 shows an alternate bracket assembly 400 which may be replaced for each of brackets 40, 42 in trailer 10, as shown in FIG. 1. Bracket assemblies may also be referred to as a “hub member” or “locking hub member”. Bracket assembly 400 has a housing 401 that receives ends of tubes 402a-d. Bracket assembly 400 may lock orientation of tubes 402a-d or may be manipulated to an unlocked position thereby permitting pivotal rotation of tubes 402a-d around pivot axes 404a-d, respectively. Handle 408 is provided to control the inner locking mechanism which is illustrated in the cut-away view in FIG. 23.

As shown in FIG. 23, tubes 402a and 402b each have a serrated or sprocket-like end that engages a concave serrated surface of locking member 416. When serrated end portions 412a and 412b engage locking member 416, then tubes 402a and 402b are prevented from rotating around axes 404a and 404b, respectively. In the embodiment shown in FIGS. 22-26, tubes 402c and 402d are not locked. However, housing 401 prevents tubes 402c and 402d from pivoting upward signficantly above their orientations shown in FIG. 23. In use, gravity and loading of the trailer counter any tendency for tubes 402c and 402d to rotate downward.

FIG. 24 shows bracket assembly 400 with tubes 402a-d collapsed. Locking member 416 locks tubes 402a and 402b in their collapsed position. FIGS. 25 and 26 show sectional views through assembly 400, illustrating the mechanism that allows locking and unlocking of assembly 400. In FIG. 25, locking member 416 is engaging serrated end portion 412a of rigid tube 402a. A spring 420 exerts a force between a wall of housing 401 and locking member 416 to keep assembly 400 in a locked position. Handle 408 is connected to locking member 416 by supports 422. As shown in FIG. 26, handle 408 can be pulled upward causing upward movement of locking member 416 out of engagement with serrated end portion 412a, thereby allowing pivotal rotation of tube 402a around pivotal axis 404a. FIG. 27 shows an exploded view of bracket assembly 400.

FIG. 28 shows an alternate embodiment of the invention. Bracket assembly 430 has a housing 431 that receives tubes 432a-d. Each of tubes 432a-d has a serrated, sprocket-like end portion 436a-d, respectively. Locking member 438 has internal concave serrated surfaces that complement each of serrated end portions 436a-d, so that locking member 438 locks effective pivotal movement of all four tubes in contrast to bracket assembly 400 which locks only the upper tubes. Handle 440, shown in dashed lines is connected to locking member 438, and functions in the same manner as previously described for assembly 400.

While the invention has been disclosed in certain preferred forms, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

We claim:

1. A bicycle trailer comprising
a bed portion configured to carry a load, the bed portion having a frame structure supporting a seat portion, the frame structure being formed by front and back portions and a pair of opposing lateral portions, each of the front and back portions being collapsible to substantially reduce a side-to-side dimension of the trailer for storage or transport,
at least one wheel connected to the bed portion for transporting the bed portion over ground, and
a hitch assembly connected the bed portion configured to link the trailer to a bicycle.

2. The trailer of claim 1, wherein each of the front and back portions of the frame structure has a hub member that permits folding of the frame structure downward when the hub member is in an unlocked position.

3. The trailer of claim 1, wherein each lateral portion of the frame structure is connected to a wheel.

4. The trailer of claim 1, wherein the bed portion is connected to the hitch assembly via a tongue member.

5. The trailer of claim 1, wherein the tongue member includes a flexible linkage member to permit a degree of flexible movement between the trailer and a bicycle.

6. The trailer of claim 1, wherein the frame structure is formed from at least two U-shaped rigid tubes that are connected by front and back hub members.

7. The trailer of claim 6, wherein each hub member has a locked position that prevents the rigid tubes from collapsing relative to each other and an unlocked position that permits pivotal movement of the tubes relative to the hub member.

8. The trailer of claim 6, wherein each hub member has a handle that is biased toward maintaining a locked position, and that can be manipulated to transition the hub member to an unlocked position so the frame structure can be collapsed.

9. The trailer of claim 8, wherein the frame structure is formed by four U-shaped tubes connected by front and back hub members, each hub member being configured to alternately lock and permit pivotal movement of the tubes relative to the hub member, so that the frame structure can be maintained in a stable open position for use, and alternately in a collapsed position for storage or transport.

10. The trailer of claim 9, wherein each hub member provides a pair of upper to pivot points for two of the tubes, and a pair of lower pivot points for the other two tubes, the upper pivot points being spaced apart from each other more than the space between the lower pivot points.

11. A bicycle trailer comprising
a bed portion configured to carry a load, the bed portion having a frame structure supporting a seat portion, the frame structure having front and back hub members that permit folding of the frame structure to substantially reduce a side-to-side dimension of the trailer for storage or transport,
at least one wheel connected to the bed portion for transporting the bed portion over ground, and
a hitch assembly connected to the bed portion configured to link the trailer to a bicycle.

12. The trailer of claim 11, wherein the hub members permit folding of the frame structure in a downward direction.

13. The trailer of claim 11, wherein the bed portion has two wheels located on opposing lateral sides of the bed portion.

14. The trailer of claim 11, further comprising a tongue member connected to the bed portion, the hitch assembly being connected to a distal end of the tongue member.

15. The trailer of claim 11, wherein the hitch assembly is connected to the bed portion via a flexible linkage member that permits a degree of relative movement between the trailer and a bicycle.

16. The trailer of claim 11, wherein the frame structure is formed by four U-shaped tubes connected by front and back hub members, each hub member being configured to alternately lock and permit pivotal movement of the tubes relative to the hub members so that the frame structure can be maintained in a stable open position for use, and alternately in a collapsed position for storage or transport.

17. The trailer of claim 16, wherein each hub member provides a pair of upper pivot points for two of the tubes, and a pair of lower pivot points for the other two tubes, the upper pivot points being spaced apart from each other more than the space between the lower pivot points.

18. The trailer of claim 11, wherein the hitch assembly includes a clamp mechanism and a knob that is seated in a ratchet socket configured to allow tightening of the clamp and to resist untightening.

19. The trailer of claim 11, wherein the hitch assembly includes a clamp portion configured to clamp a chainstay tube on a bicycle, and a fork portion configured to fit around a seatstay on the bicycle.

20. The trailer of claim 19, further comprising a safety pin engaging the fork portion to prevent the seatstay from disengaging the fork portion of the hitch assembly.

21. A bicycle trailer comprising
a bed portion configured to carry a load, the bed portion having a frame structure supporting a seat portion, the frame structure being formed by four U-shaped tubes connected by front and back hub members, each hub member being configured to alternately lock and permit pivotal movement of the tubes relative to the hub member so that the frame structure can be maintained in a stable open position for use, and alternately in a collapsed position for storage or transport,
at least one wheel connected to the bed portion for transporting the bed portion over ground, and
a hitch assembly connected to the bed portion configured to link the trailer to a bicycle.

22. The trailer of claim 21, wherein the frame structure has two opposing lateral sides, each side having a wheel for enabling forward movement of the trailer over ground.

23. The trailer of claim 21, wherein the hitch assembly has a clamp and a tightening mechanism that is biased into a position where the clamp can be tightened, but not untightened.

24. The trailer of claim 21, wherein the bed portion is connected to a tongue member, the hitch assembly being connected to a distal end of the tongue member.

25. The trailer of claim 21, further comprising a flexible linkage member connecting the bed portion to the hitch assembly to allow a degree of flexible movement between the trailer and a bicycle.

26. The trailer of claim 21, wherein the hinge assembly has a clamp, and a ratchet mechanism for securely tightening the clamp onto a rigid tube on a bicycle.

27. The trailer of claim 2 1, wherein each hub member has a handle that is biased toward locking movement of the tubes relative to the hub member, and that can be manipulated to permit relative movement of the tubes so that the trailer can be collapsed for storage or transport.

28. A bicycle trailer comprising
a bed portion configured to carry a load,
at least one wheel connected to the bed portion for transporting the bed portion over ground, and
a hitch assembly connected to the bed portion for connecting the trailer to a bicycle, the bitch assembly having a clamp and a tightening mechanism that is biased into a position where the clamp can be tightened but not untightened.

29. The trailer of claim 28, wherein the hitch assembly further comprises a fork structure for fitting around a seatstay on a bicycle, the clamp being configured to engage a chainstay on the bicycle.

30. The trailer of claim 28, wherein the tightening mechanism includes a ratchet device.

31. The trailer of claim 28, wherein the bed portion has a tongue, the hitch assembly being located on a distal end of the tongue.

32. The trailer of claim 28, wherein the bed portion is connected to the hitch assembly via a flexible linkage member to permit a degree of flexible movement between the trailer and bicycle.

33. The trailer of claim 28, wherein the tightening mechanism includes a spring biasing the tightening mechanism into a position where the clamp can be tightened but not untightened.

34. The trailer of claim 33, wherein the hitch assembly further comprises a knob that can be forced against the spring into a second position where the clamp can be untightened.

35. The trailer of claim 28, wherein the b ed portion has two opposing lateral sides, each side having a wheel for transporting the trailer over ground.

36. The trailer of claim 28, further comprising flexible, water-resistant walls and a removable cover over the bed portion.

37. A bicycle trailer comprising
a bed portion configured to carry a load,
at least one wheel connected to the bed portion for transporting the bed portion over ground,
a hitch assembly connected to the bed portion for connecting the bicycle trailer to a bicycle, the hitch assembly including a clamp mechanism and a knob that is seated in a ratchet socket configured to allow tightening of the clamp and to resist untightening.

38. The trailer of claim 37, wherein the bed portion has two opposing lateral sides, each side having a wheel for transporting the trailer behind a bicycle.

39. The trailer of claim 37, wherein the bed portion has a tongue, the hitch assembly being connected to a distal end of the tongue.

40. The trailer of claim 37, wherein the bed portion is connected to the hitch assembly via a flexible linkage member to allow a degree of flexible movement between the trailer and a bicycle.

41. The trailer of claim 37, wherein the knob has a serrated face that is spring-biased into engagement with the ratchet socket.

42. The trailer of claim 41, wherein the knob can be forced against the spring into a second position where the clamp can be untightened.

43. The trailer of claim 37, wherein the bed portion has a frame structure supporting a seat portion, the frame structure being formed by front and back portions, and a pair of opposing lateral portions, each of the front and back portions of the frame structure being collapsible to substantially reduce a side-to-side dimension of the trailer for storage or transport.

44. The trailer of claim 37, wherein the bed portion has a frame structure supporting a seat portion, the frame structure being formed by four U-shaped tubes connected by front and back hub members, each hub member being configured to alternately lock and permit pivotal movement of the tubes relative to the hub member, so that the frame structure can be maintained in a stable open position for use, and alternately in a collapsed position for storage or transport.

45. The trailer of claim 44, wherein the hub members permit folding of the frame structure in a downward direction.

46. A bicycle trailer comprising
a bed portion configured to carry a load,
at least one wheel connected to the bed portion for transporting the bed portion over ground, and
a hitch assembly device connected to the bed portion for connecting the bicycle trailer to a bicycle, the hitch assembly having a clamp device configured to clamp a chainstay tube on a bicycle, and a fork portion configured to fit around a seatstay on the bicycle.

47. The trailer of claim 46, wherein the bed portion has two opposing lateral sides, each side having a wheel for transporting the trailer over ground.

48. The trailer of claim 46, further comprising a pin engaging the fork portion to prevent the seatstay from disengaging the fork portion.

49. The trailer of claim 46, wherein the clamp device has a knob that is seated in a ratchet socket configured to allow tightening of the clamp and to resist untightening.

50. The trailer of claim 46, wherein the clamp device has a tightening knob that is biased into a position where the clamp can be tightened but not untightened.

51. The trailer of claim 46, wherein the bed portion has a tongue, the hitch assembly being connected to a distal end of the tongue.

52. The trailer of claim 46, wherein the bed portion is connected to the hitch assembly via a flexible linkage member to allow a degree of flexible movement between a trailer and a bicycle.

53. The trailer of claim 46, wherein the clamp device has a knob that is seated in a ratchet socket configured to allow tightening of the clamp and to resist untightening, the knob being biased into a position where the clamp can be tightened, but not untightened, so that the knob can be forced against the spring into a second position where the clamp can be untightened.

54. A bicycle trailer comprising
a bed portion configured to carry a load,
at least one wheel connected to the bed portion for transporting the bed portion over ground, and
a hitch assembly device connected to the bed portion for connecting the bicycle trailer to a bicycle, the hitch assembly having a clamp device and a ratchet mechanism for securely tightening the clamp onto a rigid tube on a bicycle.

55. The trailer of claim 54, wherein the clamp is configured to receive a chainstay.

56. The trailer of claim 54, further comprising a fork structure for receiving a seatstay.

57. The trailer of claim 54, further comprising a pin engaging the fork structure to prevent the seatstay from disengaging the fork structure.

58. The trailer of claim 54, wherein the knob member is spring-biased into a ratchet-engaging position that permits tightening, but not untightening.

59. The trailer of claim 58, wherein the knob can be forced against the spring-bias to a ratchet-disengaged position where the knob can be manipulated to untighten the clamp device.

60. The trailer of claim 58, wherein the bed portion has two opposing lateral sides, each side having a wheel for transporting the trailer over ground.

61. A bicycle trailer comprising
a bed portion adapted to carry a load,
at least one wheel adapted to support the bed portion, and
a hitch assembly adapted to connect the bed portion to a bicycle, where the hitch assembly includes a tightening member that is rotated one direction to secure the hitch assembly to the bicycle and rotated an opposite direction to release the hitch assembly from the bicycle, and where the hitch assembly further includes a selectively engageable securement mechanism configured, when engaged, to prevent rotation of the tightening member in the opposite direction while permitting rotation in the one direction.

62. A bicycle trailer comprising
a frame assembly, where the frame assembly includes a pair of longitudinally extending opposed elongate side members, where the frame assembly is moveable between a folded configuration in which the side members are close together and a deployed configuration in which the side members are spaced apart,
a hitch adapted to couple the frame assembly to the bicycle,
at least one wheel adapted to support the frame assembly, and
a collapsible seat disposed between the side members whereby the seat is collapsed when the frame assembly is folded and the seat is extended when the frame assembly is deployed.

63. A bicycle trailer comprising
a frame assembly,
a hitch adapted to couple the frame assembly to the bicycle, and
a cover adapted to fit at least partially over the frame assembly, where the cover includes at least one opening and a flexible hatch attached to the cover adjacent an edge of the opening and configured to selectively cover the opening, the cover further including a pocket disposed adjacent the edge of the opening where the hatch is attached, and where the pocket is configured to receive at least a portion of the hatch when the hatch is not covering the opening.

64. A bicycle trailer comprising
a frame assembly having a forward end, and laterally spaced sides,
a hitch configured to connect the frame assembly to the bicycle,
a pair of wheels disposed on each side of the frame assembly, where the wheels project beyond the frame assembly on each side, and
a pair of fenders connected to the frame assembly in front of each wheel, where the fenders project laterally sufficiently to prevent objects from becoming caught between the wheels and the frame assembly when the trailer is moving in the forward direction, and where the fenders do not obstruct removal of the wheels in a lateral direction.

65. A bicycle trailer comprising
a frame assembly having a central axis corresponding to a direction of travel and including left and right frame portions coupled together generally along the central axis to fold in a generally pivotal manner about the central axis,
each frame portion including a wheel carrying structure mounted thereon,
where each wheel carrying structure establishes a plane of rotation for a corresponding wheel and the wheel carrying structures are mounted to the frame portions so that the wheel carrying structures move toward each other while maintaining the plane of rotation of the wheels in a generally parallel orientation to each other as the left and right frame portions are folded and unfolded.

66. The trailer of claim 65 further comprising a pair of fenders connected to the frame portions in front of each wheel, where the fenders project laterally sufficiently to prevent objects from becoming caught between the wheels and the frame portions when the trailer is moving in the forward direction, and where the fenders pivot relative to the wheels when the frame portions are folded.

67. A bicycle trailer, comprising:
a frame assembly;
a hitch adapted to couple the frame assembly to a bicycle;
at least one wheel adapted to support the frame assembly; and
a seat mounted in the frame assembly, the seat including a backrest with at least a region of stretchy material.

68. A bicycle trailer comprising,
a frame assembly including at least one elongate tube member with a straight section and a generally arcuate bend therein, the frame assembly further including at least one unitary member with an elongate passage shaped to fit snugly about the straight section, where the passage is shaped to allow the unitary member to slide around the arcuate bend in the elongate tube member,
a hitch adapted to couple the frame assembly to the bicycle, and
at least one wheel adapted to support the frame assembly.
